(19) United States
(12) Patent Application Publication
(10) Pub. No.: US 2021/0363881 A1
(43) Pub. Date: Nov. 25, 2021

(54) SYSTEM AND METHOD FOR MONITORING DISCONNECTED WELLS

(71) Applicant: PETRÓLEO BRASILEIRO S.A. - PETROBRAS, Rio de Janeiro (BR)

(72) Inventors: Marcos Vinicius DA SILVA NOBREGA, Rio de Janeiro (BR); Marcio ALBUQUERQUE DE SOUZA, Rio de Janeiro (BR); Hugo Francisco LISBOA SANTOS, Rio de Janeiro (BR); Cedric HERNALSTEENS, Niterói (BR)

(73) Assignee: PETRÓLEO BRASILEIRO S.A. - PETROBRAS, Rio de Janeiro (BR)

(21) Appl. No.: 17/278,187

(22) PCT Filed: Jul. 17, 2019
(86) PCT No.: PCT/BR2019/050278

§ 371 Date: Mar. 19, 2021

(30) Foreign Application Priority Data
Sep. 21, 2018 (BR) 10 2018 069281 0

(51) Int. Cl. E21B 47/14; E21B 17/02; H04B 7/185; H04B 11/00

(52) U.S. Cl. CPC E21B 47/14; E21B 17/028; E21B 2200/20; H04B 11/00; H04B 7/185

(57) ABSTRACT

The present invention relates to the monitoring of disconnected subsea oil wells. In this scenario, the present invention provides a system for monitoring disconnected wells comprising (i) means for acquiring and processing (12) monitoring data from the WCT (20) and/or from the well, the means for acquiring and processing (12) being connected to the sensors of the WCT (20) and/or of the well, (ii) means for verifying (12) the monitoring data from the WCT (20) and/or from the well and comparing them with predetermined values, and (iii) means for signaling (14, 16) designed to send at least one signal in the event an abnormality is detected through comparison of the data with the predetermined values. The present invention further provides a method associated with the above-mentioned system.

### FIELD OF THE INVENTION

The present invention relates to the monitoring of subsea oil wells. More specifically, the present invention relates to the monitoring of disconnected subsea oil wells.

### BACKGROUND OF THE INVENTION

According to the legislation in force, all subsea oil wells that have been disconnected for more than three years must have monitoring mechanisms to alert to the occurrence of unsafe conditions that may lead to an environmental incident.

Disconnected subsea oil wells are currently monitored by means of a portable system that queries the instruments of a Wet Christmas Tree (WCT) and that has the capacity to query and store data in a short time frame, while connected. However, that system needs the support of a specialized vessel and ROV to perform the subsea connection and to collect data. Furthermore, the data collection must be repeated periodically, which results in significant monitoring costs.

Continuous subsea monitoring systems are known in the state of the technique, as shown in the following examples.

Document CN1804923A reveals an automatic monitoring system for long-term anchorage in deep water that comprises: a monitoring structure, a sensor, a data collection module, a long-distance wireless acoustic model, and a fixed cell on the structure. The data collection module is connected to the module of the data communication system; the data communication system module transmits the data from monitoring after processing from the data collection system module to the long-distance wireless acoustic modem by the series interface; the modem is connected to the computer by the microprocessor and by the standard series interface, which may transmit the data to the computer.

Document U.S. Pat. No. 7,261,162B2 reveals a subsea communication system in which the data collected by sensors in the well are transmitted to the surface by a subsea communication module. That document further reveals that the data should preferably be sent using fiber optic systems.

However, neither of the documents mentioned above specifically discusses monitoring of disconnected wells. Furthermore, in the event of a communication failure between the subsea monitoring systems and the vessels/platforms on the surface, there is no backup system capable of issuing an alert if there is an incident at the well. For the case of disconnected wells, for example, an incident at a well can cause immeasurable environmental damage.

As will be better detailed below, the present invention seeks to resolve the problem described above in the state of the technique in a practical and efficient manner.

### SUMMARY OF THE INVENTION

The main purpose of the present invention is to provide a system and a method for monitoring disconnected wells that is low cost and very efficient, to provide alerts regarding any incidents and the well and/or the WCT.

In order to attain the objective described above, the present invention provides a system for monitoring disconnected wells comprising (i) means for acquiring and processing monitoring data from the WCT and/or from the well, the means for acquiring and processing being connected to the sensors of the WCT and/or of the well, (ii) means for verifying the monitoring data from the WCT and/or from the well and comparing them with predetermined values, and (iii) means for signaling designed to send at least one signal in the event any abnormality is detected upon comparison of the data with the predetermined values.

The present invention further provides a method for monitoring disconnected wells comprising the steps of (i) acquiring and processing the monitoring data from the WCT and/or from the well, in which the means for acquisition and processing are connected to the sensors of the WCT and/or of the well, (ii) verifying the monitoring data from the WCT and/or from the well and comparing them with predetermined values, and (iii) sending, from the signaling means, at least one signal in the event of detection of any abnormality upon comparison of the data with the predetermined values.

### BRIEF DESCRIPTION OF THE FIGURES

The detailed description presented below references the attached figures and their respective reference numbers.

FIG. 1 contains a block diagram of the monitoring system according to this invention.

FIG. 2 contains an isometric schematic view of the system according to this invention.

### DETAILED DESCRIPTION OF THE INVENTION

First, it is noted that the following description will start from a preferred embodiment of the invention. As will be evident to anyone versed the matter, however, the invention is not limited to this specific embodiment.

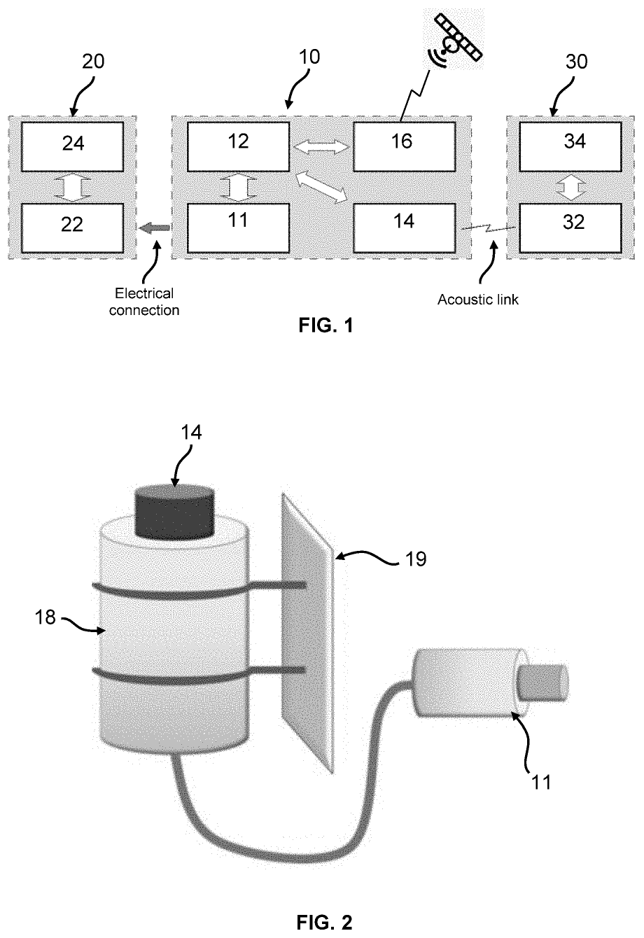

FIG. 1 contains a block diagram of the monitoring system according to this invention. FIG. 2, in turn, contains an isometric schematic view of the system according to this invention.

As can be seen in FIG. 1, the monitoring system for disconnected wells 10 of the present invention is connected to the WCT 20 preferably by means of a connection through an electrical cable. The WCT 20 preferably contains a connection panel 22, where a connecting element 11 of the system of the present invention is connected. The connection panel 22 is connected to the sensors 24 located in the well (PDG) and to the monitoring sensors of the WCT itself 20.

The system of the present invention comprises means for acquiring and processing monitoring data from the WCT and/or from the well. Preferably, the means for acquiring and processing are a central processing unit 12. Optionally, the central processing unit 12 also functions as a means for storing the collected data.

The central processing unit 12 is responsible for autonomously controlling the reading and storage of the data from the sensors installed on the WCT 20 and in the well.

The system of the present invention further comprises means for verifying the monitoring data from the WCT 20 and/or from the well, and comparing them to predetermined values. In other words, the system of the present invention evaluates whether the monitoring data are inside a control envelope (normal conditions). Preferably, the central processing unit 12 is also responsible for verification of the data.

If the data are not within the control envelope, and means of signaling is activated to signal the detection of an abnormality in the verified data.

The means of signaling may be, for example, a subsea hydroacoustic model 14 designed to send to a receiving system on the surface 30 at least one signal in the event an abnormality is detected. Preferably, the receiving system on the surface 30 comprises a surface hydroacoustic modem 32.

In an alternative embodiment, the subsea hydroacoustic modem 14 may send data detected at the WCT and/or the well periodically or from an inquiry from the surface hydroacoustic system 32, even if the system has not detected an abnormality in the monitoring parameters.

The central processing unit 12 may, for example, store the data in the subsea hydroacoustic model 14 and the latter remains on stand-by until it is queried by the surface hydroacoustic modem 32. Once queried, the subsea hydroacoustic modem 14 sends the data to the surface hydroacoustic modem 32 which transmits the data to a monitoring center 34.

Preferably, as shown in FIG. 2, this system is physically comprised of: (i) an electrical connector 11 and electric jumper, which create the interface with the panel 22 of the WCT 20; (ii) pressure vessel 18 containing in its interior the central processing unit and battery for power; (iii) subsea hydroacoustic modem 14; and (iv) magnetic connector 19, which couples the system in the structure of the WCT 20.

Alternatively, the means for signaling may be, for example, a subsea buoy release system 16, wherein the buoys comprise means for transmitting signals from the ocean surface to a monitoring satellite, the buoys being released upon detection of an abnormality. In this embodiment, the subsea buoy release system 16 is controlled by the central processing unit 12.

Preferably, the subsea buoy release system 16 comprises a receptacle (not shown) designed to house a plurality of buoys. The receptacle is provided with an individual release mechanism for the buoys.

Each buoy preferably comprises embedded electronics designed for data storage and transmission (broadcast) on a telecommunications satellite frequency bandwidth with the capacity to be captured by a monitoring satellite. The central processing unit 12 downloads the data from the WCT and from the well into the buoy storage system and releases it in the direction of the surface. Once on the surface, the buoy transmits the data to monitoring satellites that retransmit the information to land-based monitoring centers.

The present invention further provides a method for monitoring disconnected wells associated with the system described above, comprising the steps of:

(i) acquisition and processing of the monitoring data from the WCT 20 and/or from the well, in which the means for acquisition and processing 12 are connected to the sensors on the WCT 20 and/or the well;

(ii) verifying the monitoring data from the WCT 20 and/or from the well, and comparing them to predetermined values;

(iii) sending, from the means for signaling 14, 16, at least one signal in the event that any abnormality is detected through comparison of the data with the predetermined values.

It is noted that all the operating steps of the system described above also apply to the present monitoring method.

Countless variations to the scope of protection of this application are permitted. Thus, the fact that the present invention is not limited to the specific configurations/embodiments described above is reinforced.

1. A system for monitoring disconnected wells wherein it comprises:
means for acquiring and processing (12) the monitoring data from the WCT (20) and/or the well, the means for acquiring and processing (12) being connected to the sensors of the WCT (20) and/or of the well;
means for verifying (12) the monitoring data from the WCT (20) and/or from the well, and comparing them to predetermined values;
means for signaling (14, 16) designed to send at least one signal in the event that an abnormality is detected by comparing the data with the predetermined values.

2. The system of claim 1, wherein it further comprises means for storing (12) monitoring data from the WCT (20) and/or from the well.

3. The system of claim 2, wherein the means for acquisition, storage, processing and verification contain at least one central processing unit (12) connected to the parameter-monitoring sensors of the WCT (20) and/or of the well.

4. The system of claim 3, wherein at least one central processing unit (12) is housed inside a pressure vessel (18) attached to the WCT structure (20) by means of a magnetic connector (19).

5. The system of claim 1, wherein the means of signaling are at least one of:
a subsea hydroacoustic model (14) designed to send to a surface hydroacoustic modem (32) at least one signal in the event that an abnormality is detected;
at least one subsea buoy release system, wherein the buoys comprise means for transmitting signals from the ocean surface to a monitoring satellite, the buoys being released upon detection of an abnormality.

6. A system for monitoring disconnected wells wherein it comprises the steps of:
acquisition and processing of the monitoring data from the WCT (20) and/or from the well, wherein the means for acquisition and processing (12) are connected to the sensors on the WCT (XX) and/or the well;
verifying the monitoring data from the WCT (20) and/or from the well, and comparing them to predetermined values; and
sending, from the means for signaling (14, 16), at least one signal in the event that an abnormality is detected through comparison of the data with the predetermined values.

7. The system of claim 2, wherein the means of signaling are at least one of:
a subsea hydroacoustic model (14) designed to send to a surface hydroacoustic modem (32) at least one signal in the event that an abnormality is detected;
at least one subsea buoy release system, wherein the buoys comprise means for transmitting signals from the ocean surface to a monitoring satellite, the buoys being released upon detection of an abnormality.

8. The system of claim 3, wherein the means of signaling are at least one of:
a subsea hydroacoustic model (14) designed to send to a surface hydroacoustic modem (32) at least one signal in the event that an abnormality is detected;
at least one subsea buoy release system, wherein the buoys comprise means for transmitting signals from the ocean surface to a monitoring satellite, the buoys being released upon detection of an abnormality.

9. The system of claim 4, wherein the means of signaling are at least one of:
a subsea hydroacoustic model (14) designed to send to a surface hydroacoustic modem (32) at least one signal in the event that an abnormality is detected;
at least one subsea buoy release system, wherein the buoys comprise means for transmitting signals from the ocean surface to a monitoring satellite, the buoys being released upon detection of an abnormality.
